(19) United States
(12) Patent Application Publication
(10) Pub. No.: US 2023/0362697 A1
(43) Pub. Date: Nov. 9, 2023

(54) METHOD FOR NETWORK ELEMENT, NETWORK ELEMENT, METHOD FOR USER EQUIPMENT, USER EQUIPMENT AND APPARATUS

(71) Applicant: Apple Inc., Cupertino, CA (US)

(72) Inventors: Qiming LI, Beijing (CN); Dawei ZHANG, Saratoga, CA (US); Huaning NIU, San Jose, CA (US); Jie CUI, San Jose, CA (US); Manasa RAGHAVAN, Sunnyvale, CA (US); Xiang CHEN, Campbell, CA (US); Yang TANG, San Jose, CA (US)

(73) Assignee: Apple Inc., Cupertino, CA (US)

(21) Appl. No.: 17/441,398

(22) PCT Filed: Jan. 15, 2021
(86) PCT No.: PCT/CN2021/072014

§ 371 Date: Sep. 21, 2021

(51) Int. Cl. H04W 24/10

(52) U.S. Cl. CPC H04W 24/10

(57) ABSTRACT

A method for a network element is provided. The method comprises: determining multiple concurrent measurement gap (MG) patterns; encoding a message for transmission to a user equipment (UE) including MG configuration information that includes an indication of the multiple concurrent MG patterns, wherein the indication of the multiple concurrent MG patterns includes at least time offsets for respective MG patterns; and transmitting the message to the UE.

### FIELD OF THE INVENTION

The present disclosure may relate in general to a field of wireless communications, and more particularly to methods for network elements, network elements, methods for user equipment, user equipment and apparatus.

### BACKGROUND OF THE INVENTION

In order to facilitate smooth network transitions (e.g., cell handovers, redirection, reselection, or the like) with high a quality of experience (QoE), a user equipment (UE) has to have the capability to measure surrounding cells and provide related data to the network (NW). The UE may need measurement gaps (MG) to perform measurements when it cannot measure the target frequency while simultaneously transmitting/receiving on the serving cell.

### SUMMARY OF THE INVENTION

An aspect of the present disclosure mainly aims to methods for network elements, network elements, methods for user equipment, user equipment and apparatus.

In accordance with some exemplary embodiments of the present disclosure, a method for a network element is provided. The method may comprise: determining multiple concurrent measurement gap (MG) patterns; encoding a message for transmission to a user equipment (UE) including MG configuration information that includes an indication of the multiple concurrent MG patterns, wherein the indication of the multiple concurrent MG patterns includes at least time offsets for respective MG patterns; and transmitting the message to the UE.

In accordance with some exemplary embodiments of the present disclosure, a network (NW) element is provided. The network (NW) element may comprise: processor circuitry configured to cause the NW element to perform the above mentioned method.

In accordance with some exemplary embodiments of the present disclosure, an apparatus for operating a network (NW) element is provided. The apparatus may comprise: processor circuitry configured to cause the NW element to perform the above mentioned method.

In accordance with some exemplary embodiments of the present disclosure, a method for a user equipment (UE) is provided. The method may comprise: encoding a message for transmission to a network (NW) element including concurrent MG pattern ability information of the UE, wherein the concurrent MG pattern ability information is based on multiple concurrent MG patterns that are supported by the UE; and transmitting the message to the NW element.

In accordance with some exemplary embodiments of the present disclosure, a user equipment (UE) is provided. The UE may comprise: processor circuitry configured to cause the UE to perform the above mentioned method.

In accordance with some exemplary embodiments of the present disclosure, an apparatus for operating a user equipment (UE) is provided. The apparatus may comprise: processor circuitry configured to cause the UE to perform the above mentioned method.

In accordance with some exemplary embodiments of the present disclosure, an apparatus is provided. The apparatus may comprise: a memory configured to store concurrent MG pattern ability information of a user equipment (UE), wherein the concurrent MG pattern ability information is based on multiple concurrent MG patterns that are supported by the UE; and processor circuitry, coupled to the memory, configured to cause the UE to: retrieve the concurrent MG pattern ability information from the memory; encode a message for transmission to a network (NW) element including the concurrent MG pattern ability information; and transmit the message to the NW element.

In accordance with some exemplary embodiments of the present disclosure, a non-transitory computer-readable memory medium is provided. The non-transitory computer-readable memory medium may store program instructions, where the program instructions, when executed by a computer system, cause the computer system to perform any one of the above mentioned methods.

In accordance with some exemplary embodiments of the present disclosure, a computer program product is provided. The computer program product may comprise program instructions which, when executed by a computer, cause the computer to perform any one of the above mentioned methods.

### BRIEF DESCRIPTION OF THE DRAWINGS

The above and other aspects and advantages of the present disclosure will become apparent from the following detailed description of exemplary embodiments taken in conjunction with the accompanying drawings which illustrate, by way of example, the principles of the present disclosure. Note that the drawings are not necessarily drawn to scale.

FIG. 1 illustrates an example wireless communication system, according to some embodiments;

FIG. 2 illustrates a base station (BS) in communication with a user equipment (UE) device, according to some embodiments;

FIG. 3 illustrates an example block diagram of a UE, according to some embodiments;

FIG. 4 illustrates an example block diagram of a BS, according to some embodiments;

FIG. 5 illustrates an example block diagram of cellular communication circuitry, according to some embodiments;

FIG. 6 is a flowchart diagram illustrating an example method for a NW element, according to some embodiments;

FIG. 7 is a flowchart diagram illustrating an example method for a UE, according to some embodiments;

FIGS. 8A through 8D are diagrams illustrating MG patterns supported by UEs for each frequency range (FR);

FIG. 9 illustrates an aspect of an exemplary possible concurrent MG pattern scheme, according to some embodiments;

FIG. 10 illustrates an aspect of an exemplary possible concurrent MG pattern scheme, according to some embodiments;

FIG. 11 illustrates an aspect of an exemplary possible concurrent MG pattern scheme, according to some embodiments; and

FIGS. 12A and 12B illustrate aspects of exemplary possible concurrent MG pattern schemes with different overheads, according to some embodiments.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION OF THE PREFERRED EMBODIMENTS

### Exemplary Terminology

For the purposes of the present document, the following terms and definitions are applicable to the examples and embodiments discussed herein, but are not meant to be limiting.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. The terms “application circuitry” and/or “baseband circuitry” may be considered synonymous to, and may be referred to as, “processor circuitry”.

The term “user equipment” (UE) (or “UE device”) as used herein refers to, is part of, or includes any of various types of computer systems or devices that are mobile or portable and that perform wireless communications. Examples of UE devices include mobile telephones or smart phones (e.g., iPhone™, Android™-based phones), portable gaming devices (e.g., Nintendo DS™, PlayStation Portable™, Gameboy Advance™, iPhone™), laptops, wearable devices (e.g. smart watch, smart glasses), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

The term “base station” has the full breadth of its ordinary meaning, and at least includes a wireless communication station installed at a fixed location and used to communicate as part of a wireless telephone system or radio system.

The term “network element” as used herein refers to physical or virtualized equipment and/or infrastructure used to provide wired or wireless communication network services. The term “network element” may be considered synonymous to and/or referred to as a network device, networked computer, networking hardware, network equipment, network node, router, switch, hub, bridge, radio network controller, RAN device, RAN node, gateway, server, virtualized VNF, NFVI, and/or the like. The term “base station” may be considered synonymous to, and may be referred to as, “network element”.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “band” has the full breadth of its ordinary meaning, and at least includes a section of spectrum (e.g., radio frequency spectrum) in which channels are used or set aside for the same purpose.

Various components may be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors may be configured to electrically connect a module to another module, even when the two modules are not connected). In some contexts, “configured to” may be a broad recitation of structure generally meaning “having circuitry that” performs the task or tasks during operation. As such, the component can be configured to perform the task even when the component is not currently on. In general, the circuitry that forms the structure corresponding to “configured to” may include hardware circuits.

The phrase “in various embodiments”, “in some embodiments”, and the like may refer to the same, or different, embodiments. The terms “comprising”, “having”, and “including” are synonymous, unless the context dictates otherwise. The phrase “A and/or B” means (A), (B), or (A and B). The phrases “A/B” and “A or B” mean (A), (B), or (A and B), similar to the phrase “A and/or B”. For the purposes of the present disclosure, the phrase “at least one of A and B” means (A), (B), or (A and B). The description may use the phrases “in an embodiment”, “in embodiments”, “in some embodiments”, and/or “in various embodiments”, which may each refer to one or more of the same or different embodiments. Furthermore, the terms “comprising”, “including”, “having”, and the like, as used with respect to embodiments of the present disclosure, are synonymous.

In the following detailed description, numerous specific details are set forth to provide a thorough understanding of the described exemplary embodiments. It will be apparent, however, to one skilled in the art that the described embodiments can be practiced without some or all of these specific details. In other exemplary embodiments, well known structures or process steps have not been described in detail in order to avoid unnecessarily obscuring the concept of the present disclosure.

Communication System

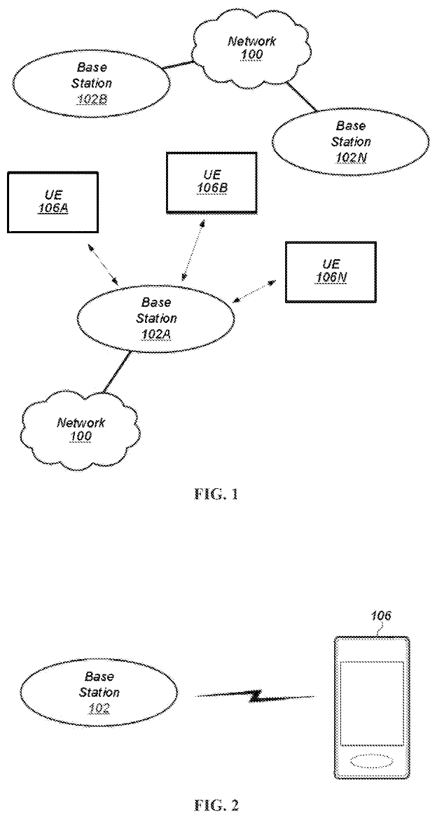

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, etc., through 106N. Each of the user devices may be referred to herein as a “user equipment” (UE). Thus, the user devices 106 are referred to as UEs or UE devices.

The base station (BS) 102A may be a base transceiver station (BTS) or cell site (a “cellular base station”), and may include hardware that enables wireless communication with the UEs 106A through 106N.

The communication area (or coverage area) of the base station may be referred to as a “cell”. The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), etc. Note that if the base station 102A is implemented in the context of LTE, it may alternately be referred to as an ‘eNodeB’ or ‘eNB’. Note that if the base station 102A is implemented in the context of 5G NR, it may alternately be referred to as a ‘gNodeB’ or ‘gNB’.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106 with various telecommunication capabilities, such as voice, SMS and/or data services.

Base station 102A and other similar base stations (such as base stations 102B . . . 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a gNB may be connected to a legacy evolved packet core (EPC) network and/or to a NR core (NRC) network. In addition, a gNB cell may include one or more transition and reception points (TRPs). In addition, a UE capable of operating according to 5G NR may be connected to one or more TRPs within one or more gNBs. For example, it may be possible that that the base station 102A and one or more other base stations 102 support joint transmission, such that UE 106 may be able to receive transmissions from multiple base stations (and/or multiple TRPs provided by the same base station).

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, HSPA, 3GPP2 CDMA2000 (e.g., 1×RTT, 1×EV-DO, HRPD, eHRPD), etc.). The UE 106 may also or alternatively be configured to communicate using one or more global navigational satellite systems (GNSS, e.g., GPS or GLONASS), one or more mobile television broadcasting standards (e.g., ATSC-M/H), and/or any other wireless communication protocol, if desired. Other combinations of wireless communication standards (including more than two wireless communication standards) are also possible.

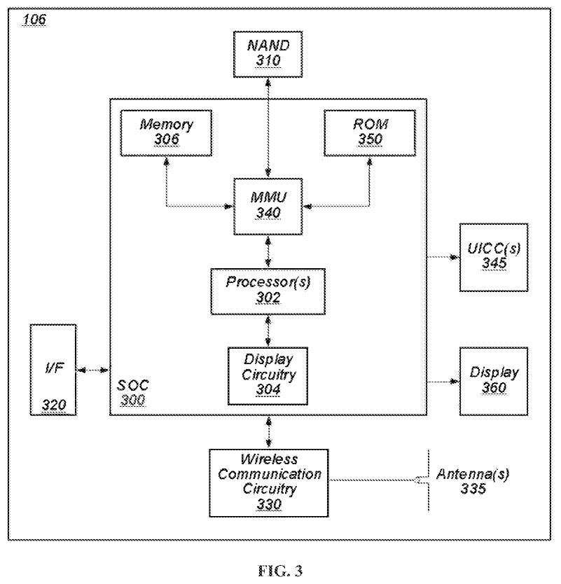

FIG. 2 illustrates user equipment 106 (e.g., one of the devices 106A through 106N) in communication with a base station 102, according to some embodiments. The UE 106 may be a device with cellular communication capability such as a mobile phone, a hand-held device, a computer, a laptop, a tablet, a smart watch or other wearable device, or virtually any type of wireless device.

The UE 106 may include a processor (processing element) that is configured to execute program instructions stored in memory. The UE 106 may perform any of the method embodiments described herein by executing such stored instructions. Alternatively, or in addition, the UE 106 may include a programmable hardware element such as an FPGA (field-programmable gate array), an integrated circuit, and/or any of various other possible hardware components that are configured to perform (e.g., individually or in combination) any of the method embodiments described herein, or any portion of any of the method embodiments described herein.

The UE 106 may include one or more antennas for communicating using one or more wireless communication protocols or technologies. In some embodiments, the UE 106 may be configured to communicate using, for example, NR or LTE using at least some shared radio components. As additional possibilities, the UE 106 could be configured to communicate using CDMA2000 (1×RTT/1×EV-DO/HRPD/eHRPD) or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or either of LTE or 1×RTT, or either of LTE or GSM, among various possibilities), and separate radios for communicating using each of Wi-Fi and Bluetooth. Other configurations are also possible.

Block Diagram of a UE

FIG. 3 illustrates an example simplified block diagram of a communication device 106, according to some embodiments. It is noted that the block diagram of the communication device of FIG. 3 is only one example of a possible communication device. According to embodiments, communication device 106 may be a user equipment (UE) device, a mobile device or mobile station, a wireless device or wireless station, a desktop computer or computing device, a mobile computing device (e.g., a laptop, notebook, or portable computing device), a tablet, and/or a combination of devices, among other devices. As shown, the communication device 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the communication device 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and wireless communication circuitry 330 (e.g., for LTE, LTE-A, NR, UMTS, GSM, CDMA2000, Bluetooth, Wi-Fi, NFC, GPS, etc.). In some embodiments, communication device 106 may include wired communication circuitry (not shown), such as a network interface card, e.g., for Ethernet.

The wireless communication circuitry 330 may couple (e.g., communicatively; directly or indirectly) to one or more antennas, such as antenna(s) 335 as shown. The wireless communication circuitry 330 may include cellular communication circuitry and/or short to medium range wireless communication circuitry, and may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include one or more receive chains (including and/or coupled to (e.g., communicatively; directly or indirectly) dedicated processors and/or radios) for multiple RATs (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with a second radio. The second radio may be dedicated to a second RAT, e.g., 5G NR, and may be in communication with a dedicated receive chain and the shared transmit chain.

The communication device 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The communication device 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the communication device 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, wireless communication circuitry 330, connector I/F 320, and/or display 360. The MMU 340 may be configured to perform memory protection and page table translation or set up. In some embodiments, the MMU 340 may be included as a portion of the processor(s) 302.

As noted above, the communication device 106 may be configured to communicate using wireless and/or wired communication circuitry. As described herein, the communication device 106 may include hardware and software components for implementing any of the various features and techniques described herein. The processor 302 of the communication device 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application Specific Integrated Circuit). Alternatively (or in addition) the processor 302 of the communication device 106, in conjunction with one or more of the other components 300, 304, 306, 310, 320, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, etc.) configured to perform the functions of processor(s) 302.

Further, as described herein, wireless communication circuitry 330 may include one or more processing elements. In other words, one or more processing elements may be included in wireless communication circuitry 330. Thus, wireless communication circuitry 330 may include one or more integrated circuits (ICs) that are configured to perform the functions of wireless communication circuitry 330. In addition, each integrated circuit may include circuitry (e.g., first circuitry, second circuitry, etc.) configured to perform the functions of wireless communication circuitry 330.

Block Diagram of a Base Station

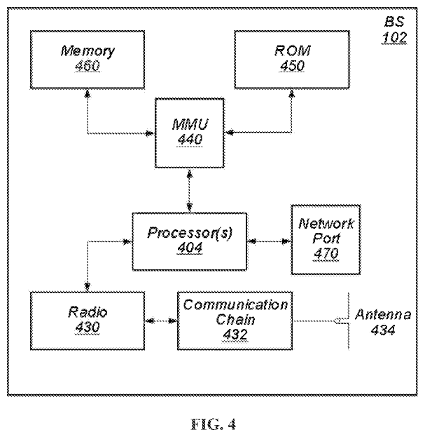

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas. The at least one antenna 434 may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and LTE, 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application Specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may include one or more processing elements. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may include one or more processing elements. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

Block Diagram of Cellular Communication Circuitry

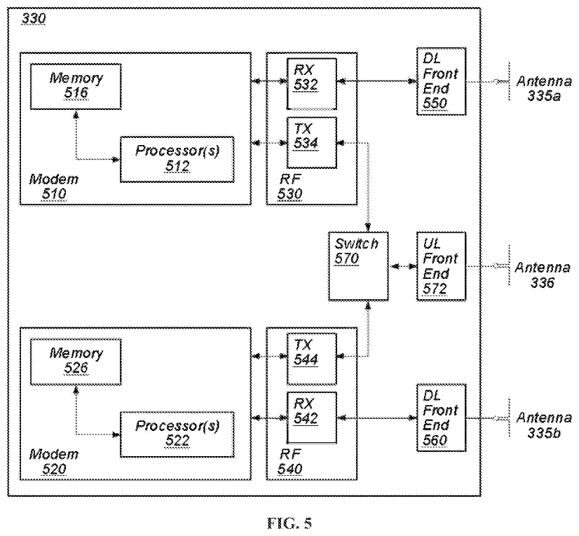

FIG. 5 illustrates an example simplified block diagram of cellular communication circuitry, according to some embodiments. It is noted that the block diagram of the cellular communication circuitry of FIG. 5 is only one example of a possible cellular communication circuit; other circuits, such as circuits including or coupled to sufficient antennas for different RATs to perform uplink activities using separate antennas, or circuits including or coupled to fewer antennas, e.g., that may be shared among multiple RATs, are also possible. According to some embodiments, cellular communication circuitry 330 may be included in a communication device, such as communication device 106 described above. As noted above, communication device 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to (e.g., communicatively; directly or indirectly) dedicated processors and/or radios) for multiple RATs (e.g., a first receive chain for LTE and a second receive chain for 5G NR). For example, as shown in FIG. 5, cellular communication circuitry 330 may include a first modem 510 and a second modem 520. The first modem 510 may be configured for communications according to a first RAT, e.g., such as LTE or LTE-A, and the second modem 520 may be configured for communications according to a second RAT, e.g., such as 5G NR.

As shown, the first modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, the second modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via the first modem 510), switch 570 may be switched to a first state that allows the first modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via the second modem 520), switch 570 may be switched to a second state that allows the second modem 520 to transmit signals according to the second RAT (e.g., via a transmit chain that includes transmit circuitry 544 and UL front end 572).

As described herein, the first modem 510 and/or the second modem 520 may include hardware and software components for implementing any of the various features and techniques described herein. The processors 512, 522 may be configured to implement part or all of the features described herein, e.g., by executing program instructions stored on a memory medium (e.g., a non-transitory computer-readable memory medium).

Alternatively (or in addition), processors 512, 522 may be configured as a programmable hardware element, such as an FPGA (Field Programmable Gate Array), or as an ASIC (Application Specific Integrated Circuit). Alternatively (or in addition) the processors 512, 522, in conjunction with one or more of the other components 530, 532, 534, 540, 542, 544, 550, 570, 572, 335 and 336 may be configured to implement part or all of the features described herein.

In addition, as described herein, processors 512, 522 may include one or more processing elements. Thus, processors 512, 522 may include one or more integrated circuits (ICs) that are configured to perform the functions of processors 512, 522. In addition, each integrated circuit may include circuitry (e.g., first circuitry, second circuitry, etc.) configured to perform the functions of processors 512, 522.

In some embodiments, the cellular communication circuitry 330 may include only one transmit/receive chain. For example, the cellular communication circuitry 330 may not include the modem 520, the RF front end 540, the DL front end 560, and/or the antenna 335b. As another example, the cellular communication circuitry 330 may not include the modem 510, the RF front end 530, the DL front end 550, and/or the antenna 335a. In some embodiments, the cellular communication circuitry 330 may also not include the switch 570, and the RF front end 530 or the RF front end 540 may be in communication, e.g., directly, with the UL front end 572.

Among other things, embodiments described herein are directed to measurement gaps (MGs) for new radio (NR) systems. Embodiments of the present disclosure may be utilized in conjunction with measurements performed by a UE, including intra-frequency and inter-frequency radio resource management (RRM) measurements. Embodiments of the present disclosure may be utilized in conjunction with messages transmitted and/or received via radio resource control (RRC) signaling between a UE and a NW element (e.g., a BS).

Two frequency ranges (FR1 and FR2) in which NR can operate according to the present version of the specification are identified in the below table (Table 1) as described in clause 5.1 of TS 38.104.

TABLE 1
Definition of frequency ranges

| Frequency range (FR) designation | Corresponding frequency range |
|---|---|
| FR1 | 410 MHz-7125 MHz |
| FR2 | 24250 MHz-52600 MHZ |

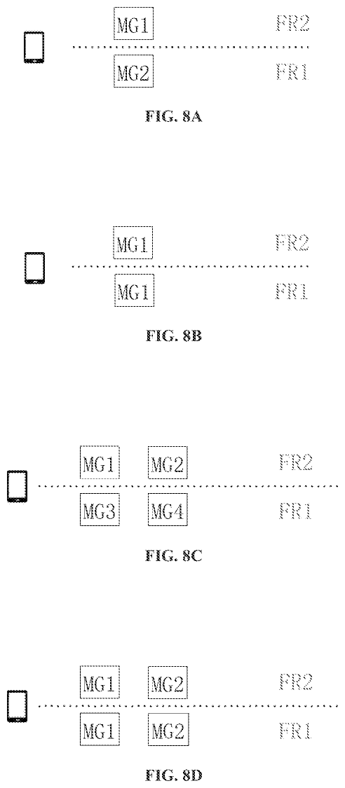

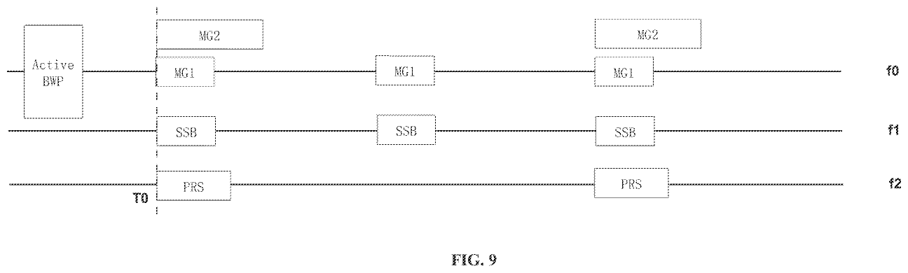

According to 3GPP specification Release 15 or 16, the independentGapConfig information element (IE) indicates whether the UE supports two independent MG configurations for FR1 and FR2, i.e., whether the UE supports per-FR gap. Only one MG pattern may be configured for a UE that does not support per-FR gap, as shown in FIG. 8B. Even for UE supporting per-FR gap, only one MG pattern may be configured for each FR, as shown in FIG. 8A, although different MG patterns may be configured for different FRs.

According to 3GPP specification Release 17, a UE may support concurrent MG patterns. Concurrent MG patterns may be configured for a UE by a NW in response to the UE supports concurrent MG patterns. The term “concurrent MG patterns” as used herein refers to multiple MG patterns configured for one UE to perform one or more measurements in the same time period. A UE is configured with multiple concurrent MG patterns in the same time period, and these MG patterns are independent of each other. Any two of the multiple concurrent MG patterns may have different pattern configurations or have an identical pattern configuration, including measurement gap length (MGL), measurement gap repetition period (MGRP), measurement gap timing advance (MGTA) and the like. The UE may use one of concurrent MG patterns to perform one measurement and use another of the concurrent MG patterns to perform another measurement, may use one or more of the concurrent MG patterns to perform one measurement, or may use one of the concurrent MG patterns to perform one or more measurements.

For a UE supports per-FR gap and concurrent MG patterns, the UE may be configured with multiple concurrent MG patterns for each FR, as shown in FIG. 8C. For a UE does not support per-FR gap but supports concurrent MG patterns, the UE may be configured with multiple concurrent MG patterns and these patterns are suitable for both FR1 and FR2, as shown in FIG. 8D. It should be noted that in FIGS. 8A through 8D, the marks MG1, MG2, MG3 and MG4 represent four different MG patterns, respectively.

However, it doesn't mean in Release 17 multiple MG patterns may be arbitrarily configured by the NW in parallel (“concurrent”) without any restriction. Several aspects have to be considered when configuring multiple concurrent MG patterns.

The First Aspect to be Considered—UE Processing Time

When performing the measurement on a target reference signal (RS), the duration of an MG usually only allows the UE to buffer the data of the RS, that is, the UE does not have enough time to process the data (including demodulation and calculation) during the MG. Therefore, some additional time for data processing is needed after completing the RS data reception, for example, after the end of the MG occasion. In view of this, if multiple concurrent MG patterns are configured for the UE, the NW shall guarantee MG occasions according to an MG pattern are not too close to MG occasions according to another MG pattern.

Solution 1 for the First Aspect

To reduce negative impact on system throughput, a solution is to align time offset of all the concurrent MG patterns. FIG. 9 illustrates an aspect of an exemplary possible concurrent MG pattern scheme, according to some embodiments. In the shown example, a UE is working on carrier f0, or, more specifically, on an active bandwidth part (BWP). The UE is configured with two measurement objectives, including synchronization signal (SS)/physical broadcast channel (PBCH) block (SSB) based L3 measurement on carrier f1 and positioning reference signal (PRS) measurement for positioning purpose on carrier f2.

Two concurrent and independent MG patterns are configured for the UE. The MGs having a first gap pattern from the two concurrent MG patterns are marked as MG1 in the figure. Since the MGs marked as MG1 (referred to as “MG1” hereinafter for simplicity) are used for the SSB based measurement as shown in the figure, the gap pattern configuration of MG1 is match the configuration of SSB. That is, the MGL of MG1 will cover the SSB duration (the term “cover” as used herein includes the meaning that the RS duration completely falls into the MG, and the length of the MG is greater than the duration in order to tune the RF to operate on the target frequency), and the MGRP will correspond to the SSB transmission periodicity. The MGs having a second gap pattern from the two concurrent MG patterns marked as MG2 (referred to as “MG2” hereinafter for simplicity) are used for the PRS measurement, and then the MGL of MG2 will cover the PRS duration and the MGRP of MG2 will correspond to the PRS transmission periodicity.

Since the PRS duration may be longer than 6 ms, the MGL of the MG2 for the PRS measurement needs to be greater than 6 ms, for example, the MG2 may have a configuration with gap pattern ID 24 (which has a 10 ms MGL) or 25 (which has a 20 ms MGL) defined in TS38.133 Table 9.1.2-1. Considering the SSB-based measurement timing configuration (SMTC) duration is much less than the PRS duration, the MGL of the MG1 may be much shorter than the MGL of the MG2.

Time offsets for respective MG patterns may be configured by the NW. A time offset is used to determine the starting point of an MG occasion. To reduce system throughput loss, the NW may arrange these RS on different carriers such that the PRS and the SSB are transmitted with no time offset difference. Accordingly, the MG1 and MG2 may start at the same time.

In this solution, it is mandatory that RSs for different measurement objectives are aligned in time and thus the MGs according to different concurrent MG pattern for the different measurement objectives are aligned so as to leave enough time for the UE to process RS data. It should be noted that the MGLs and MGRPs of the MGs according to different concurrent MG pattern may be the same or different. In this way, even for the longest MGL (usually much smaller than the corresponding MGRP), enough time may be left for data processing, which includes the period after the longest MGL ends and before the next MG with the shortest MGRP starts.

Solution 2 for the First Aspect

In Solution 1, the UE may be required to process multiple carriers, e.g., f1 and f2, simultaneously. The benefit is obvious but high UE complexity is needed to support it. To reduce UE complexity, Solution 2 is proposed. In Solution 2, MGs according to different concurrent MG patterns are required to have a certain degree of “uniform distribution”, for example, these MGs are uniformly distributed during a certain time period.

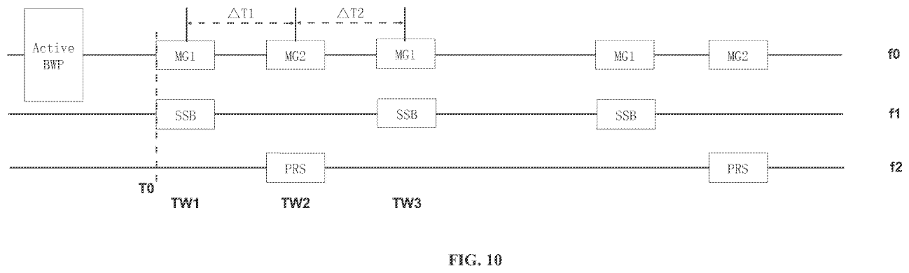

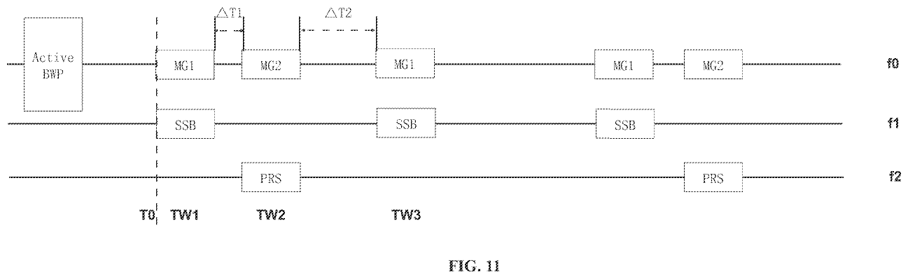

FIG. 10 illustrates an aspect of an exemplary possible concurrent MG pattern scheme, according to some embodiments. In the shown example, a UE is working on carrier f0, or, more specifically, on an active bandwidth part (BWP). The UE is configured with two measurement objectives, including SSB based L3 measurement on carrier f1 and PRS measurement for positioning purpose on carrier f2. Two concurrent and independent MG patterns are configured for the UE. The MGs having a first gap pattern from the two concurrent MG patterns, marked as MG1, are used for the SSB based measurement, and the gap pattern configuration of MG1 matches the configuration of SSB. The MGs having a second gap pattern from the two concurrent MG patterns, marked as MG2, are used for the PRS measurement, and the gap pattern configuration of MG2 matches the configuration of PRS.

One possible way for the above mentioned uniform distribution may be arrange the an MG occasion from the MG pattern with longer (or the same) MGRP to be in the middle of two MG occasions from the other MG pattern with shorter (or the same) MGRP. In the shown example, the MGRP of the MG2 is longer than the MGRP of the MG1. The NW may determine the configurations (MGL, MGRP) of the MG1 and MG2 and the time offsets for the MG1 and MG2, such that an MG2 occasion is in the middle of two adjacent MG1 occasions, that is, ΔT1=ΔT2 as shown in FIG. 10. ΔT1 may be the time distance from the time center of the MG1 in the time window TW1 to the time center of the MG2 in the time window TW2, and ΔT2 may be the time distance from the time center of the MG2 in the time window TW2 to the time center of the MG3 in the time window TW3.

In this solution, since ΔT1 is equal to ΔT2, the behaviors of the UE around the MGs will be simplified, and certain time for data processing will be guaranteed. Compared with Solution 1, the restriction on the NW in this solution will be slightly relaxed, since the two RSs are not required to be aligned in time, and there may be a time offset therebetween.

Solution 3 for the First Aspect

Sometimes the NW may not be able to align the RSs (e.g., SSB, PRS, etc.) on all carriers in time domain. In these cases, a minimum interval may be introduced, such that the NW may arrange these MGs from different MG pattern more freely on the basis of meeting the minimum interval, while the UE may have enough time to process the received RS data.

FIG. 11 illustrates an aspect of an exemplary possible concurrent MG pattern scheme, according to some embodiments. In the shown example, a UE is working on carrier f0, or, more specifically, on an active bandwidth part (BWP). The UE is configured with two measurement objectives, including SSB based L3 measurement on carrier f1 and PRS measurement for positioning purpose on carrier f2. Two concurrent and independent MG patterns are configured for the UE. The MGs having a first gap pattern from the two concurrent MG patterns, marked as MG1, are used for the SSB based measurement, and the gap pattern configuration of MG1 matches the configuration of SSB. The MGs having a second gap pattern from the two concurrent MG patterns, marked as MG2, are used for the PRS measurement, and the gap pattern configuration of MG2 matches the configuration of PRS.

In the shown example, the NW may determine the configurations (MGL, MGRP) of the MG1 and MG2 and the time offsets for the MG1 and MG2, such that either ΔT1 or ΔT2 is no less than the minimum interval. ΔT1 may be the time distance from the end of the MG1 in the time window TW1 to the beginning of the MG2 in the time window TW2, and ΔT2 may be the time distance from the end of the MG2 in the time window TW2 to the beginning of the MG3 in the time window TW3.

According to some embodiments, the minimum interval, for example with a specific value of 2 ms or else, is defined in a 3GPP specification. For example, the specification may specify different minimum intervals for different scenarios. According to some embodiments, the minimum interval may be determined based on a concurrent MG pattern ability of the UE that is reported to the NW. Depending on the UE capability, the minimum interval may be 0 ms, 1 ms, 3 ms, or the like.

According to some embodiments, the minimum interval may be specified per UE, per FR, per feature set (per band per band-combination), or even per band (band-combination), per component carrier (CC), per BWP, etc. For example, most UEs have separate baseband units respectively for FR2 (millimeter wave band) and FR1 (common frequency band). Since the FR2 has a large bandwidth and a strong baseband processing capability is required for FR2, it is allowed that the minimum interval for FR2 is shorter than the minimum interval for FR1. For another example, when working in a carrier aggregation (CA) mode or multiple carrier mode, there may be few resources for a UE to perform measurements. A minimum interval for working in a CA mode with four carriers may be longer than a minimum interval for working in a CA mode with two carriers.

This solution makes the NW may distribute RSs on different carriers in the time domain more flexibly.

The Second Aspect to be Considered—MG Overhead

Since the working frequency of the UE is different from the target frequency of a measurement objective, the UE may need MGs to perform measurements on the target frequency, and data transmission and reception on the working frequency will be suspended during the MGs. Therefore, higher MG overhead means higher data throughput loss. The NW may also need to restrict the maximum MG overhead. The MG overhead is defined as the MG proportion in time domain. For example, the MG configuration with gap pattern ID 0 (defined in the Table 9.1.2-1, TS38.133) has a 6 ms MGL and a 40 ms MGRP, and thus the MG proportion in time domain, i.e., the MG overhead, of the MG configuration with gap pattern ID 0 is 6/40=15%.

With this solution, it is possible to guarantee NW throughput by setting the maximum MG overhead.

Option 1 for the Second Aspect

According to some embodiments, the maximum overhead is determined based on a non-concurrent MG pattern supported by the UE (according to Release 15/16). A total overhead of the multiple concurrent MG patterns that are configured by the NW shall not exceed the MG overhead of the single MG pattern supported by the UE according to Release 15/16 capability IE, no matter how many concurrent MG patterns will be configured.

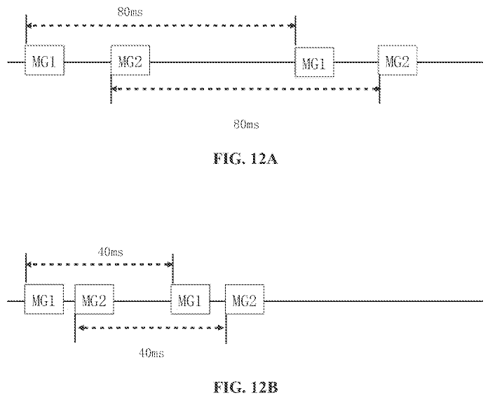

For example, the UE indicates the support of pattern ID 0 and 1 in Release 15/16 IE, which means the maximum MG overhead is 6/40=15% (according to pattern ID 0). If this UE also supports concurrent MG patterns according to Release 17, it can be configured with two concurrent MG patterns both having pattern ID 1 with different time offsets, as shown in FIG. 12A, but it should not be configured with two concurrent MG patterns both having pattern ID 1, as shown in FIG. 12B. For another example, if the UE reports that it supports MG pattern ID 4 in Release 15/16 IE, the maximum proportion that can be supported is 6 ms/20 ms, which is about 30%. Then, two concurrent MG patterns both having pattern ID 0 can be configured for the UE, or four concurrent MG patterns each having pattern ID 1 can be configured. However, two concurrent MG patterns with one having pattern ID 0 and another having pattern ID 4 should not be configured.

Option 2 for the Second Aspect

According to some embodiments, the maximum overhead is determined based on a concurrent MG pattern ability supported by the UE (according to Release 17). The concurrent MG pattern ability may include a maximum MG overhead. A total overhead of the multiple concurrent MG patterns that are configured by the NW shall not exceed the maximum MG overhead reported by the UE. The maximum overhead may be specified per UE, per FR, per feature set (per band per band-combination), or even per band (band-combination), per component carrier (CC), per BWP, etc. Since a UE may support different concurrent MG patterns in different FRs, bands, band-combinations, CCs or BWPs, different maximum overheads may be specified for different FRs, bands, band-combinations, CCs or BWPs.

For example, UE may indicate the supported maximum MG overhead is 15% in Release 17 IE. Then it can be configured with two concurrent MG patterns both having pattern ID 1 with different offsets, as shown in FIG. 12A, but it should not be configured with two concurrent MG patterns both having pattern ID 1, as shown in FIG. 12B.

Exemplary Methods of Operations for a NW Element

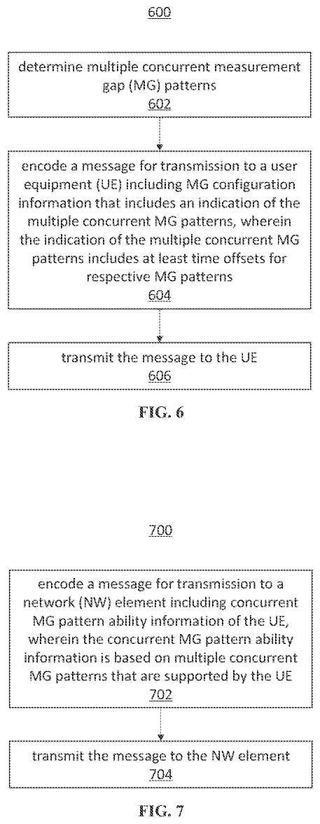

FIG. 6 is a flowchart diagram illustrating an example method 600 for a NW element (also referred to as “NW” herein for simplicity), according to some embodiments. Aspects of the method 600 may be implemented by a base station such as a BS 102 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method 600 may operate as follows.

At 602, a wireless device (also referred to as “NW” hereinafter for simplicity) may determine multiple concurrent measurement gap (MG) patterns. At 604, the wireless device may encode a message for transmission to a user equipment (UE) including MG configuration information that includes an indication of the multiple concurrent MG patterns, wherein the indication of the multiple concurrent MG patterns includes at least time offsets for respective MG patterns. At 606, the wireless device may transmit the message to the UE.

According to some embodiments, the multiple concurrent MG patterns may include first and second MG patterns, and wherein the time offset for the first MG pattern is equal to the time offset for the second MG pattern. Under this configuration, an MG according to the first MG pattern is aligned with an MG according to the second MG pattern, as described in Solution 1 for the first aspect.

According to some embodiments, the multiple concurrent MG patterns may include first and second MG patterns, the first MG pattern having a first measurement gap repetition period (MGRP) and a second MG pattern having a second MGRP, the second MGRP being no shorter than the first MGRP, and wherein the determining comprises: determining configurations and the time offsets for respective MG patterns such that an MG according to the second MG pattern is in the middle of two adjacent MGs according to the first MG pattern, as described in Solution 2 for the first aspect.

According to some embodiments, the determining may comprise: determining configurations and the time offsets for respective MG patterns such that the minimum one of time intervals between every two adjacent MGs in time domain is not less than a minimum interval, wherein one of the every two adjacent MGs is according to a first MG pattern of the multiple concurrent MG patterns, and another of the every two adjacent MGs is according to a second MG pattern of the multiple concurrent MG patterns, as described in Solution 3 for the first aspect. In some embodiments, the minimum interval is defined in a 3GPP specification. In some other embodiments, the minimum interval is determined based on a concurrent MG pattern ability of the UE, and the minimum interval may be specified for: the UE; each of frequency ranges that are supported by the UE; each of feature sets that are supported by the UE; each of bands that are supported by the UE; each of band-combinations that are supported by the UE; each of component carriers (CCs) that are supported by the UE; or each of carrier bandwidth parts (BWPs) that are supported by the UE.

According to some embodiments, the determining may comprise: determining configurations and the time offsets for respective MG patterns such that a total overhead of the multiple concurrent MG patterns is not greater than a maximum overhead, as described in the second aspect to be considered. In some embodiments, the maximum overhead is determined based on a non-concurrent MG pattern supported by the UE, as described in Option 1 for the second aspect. In some embodiments, the maximum overhead is determined based on a concurrent MG pattern ability of the UE, and the maximum overhead may be specified for: the UE; each of frequency ranges that are supported by the UE; each of feature sets that are supported by the UE; each of bands that are supported by the UE; each of band-combinations that are supported by the UE; each of component carriers (CCs) that are supported by the UE; or each of carrier bandwidth parts (BWPs) that are supported by the UE, as described in Option 2 for the second aspect.

Exemplary Operations for a UE

FIG. 7 is a flowchart diagram illustrating an example method 700 for a UE, according to some embodiments. Aspects of the method 700 may be implemented by a wireless device such as a UE 106 illustrated in various of the Figures herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In various embodiments, some of the elements of the methods shown may be performed concurrently, in a different order than shown, may be substituted for by other method elements, or may be omitted. Additional elements may also be performed as desired. As shown, the method 700 may operate as follows.

At 702, a wireless device (also referred to as “UE” hereinafter for simplicity) may encode a message for transmission to a network (NW) element including concurrent MG pattern ability information of the UE, wherein the concurrent MG pattern ability information is based on multiple concurrent MG patterns that are supported by the UE. At 704, the wireless device may transmit the message to the NW element.

According to some embodiments, the concurrent MG pattern ability information may include an indication of a minimum interval between two adjacent MGs in time domain that is supported by the UE, wherein one of the two adjacent MGs is according to a first MG pattern of the multiple concurrent MG patterns, and another of the two adjacent MGs is according to a second MG pattern of the multiple concurrent MG patterns. In some embodiments, the minimum interval may be specified for: the UE; each of frequency ranges that are supported by the UE; each of feature sets that are supported by the UE; each of bands that are supported by the UE; each of band-combinations that are supported by the UE; each of component carriers (CCs) that are supported by the UE; or each of carrier bandwidth parts (BWPs) that are supported by the UE.

According to some embodiments, the concurrent MG pattern ability information may include an indication of a maximum overhead that is supported by the UE. In some embodiments, the maximum overhead may be specified for: the UE; each of frequency ranges that are supported by the UE; each of feature sets that are supported by the UE; each of bands that are supported by the UE; each of band-combinations that are supported by the UE; each of component carriers (CCs) that are supported by the UE; or each of carrier bandwidth parts (BWPs) that are supported by the UE. In some embodiments, the indication of a maximum overhead includes an enumerated variable, such as {10%, 15%, 20%, 25%, 30%, 35%, 40%}, to indicate the maximum MG proportion in time domain that is supported by the UE.

According to some embodiments, an apparatus for operating a UE may comprise a memory configured to store concurrent MG pattern ability information of a user equipment (UE), wherein the concurrent MG pattern ability information is based on multiple concurrent MG patterns that are supported by the UE; and processor circuitry, coupled to the memory, configured to cause the UE to: retrieve the concurrent MG pattern ability information from the memory; encode a message for transmission to a network (NW) element including the concurrent MG pattern ability information; and transmit the message to the NW element.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Those skilled in the art may clearly know from the above embodiments that the present disclosure may be implemented by software with necessary hardware, or by hardware, firmware and the like. Based on such understanding, the embodiments of the present disclosure may be embodied in part in a software form. The computer software may be stored in a readable storage medium such as a floppy disk, a hard disk, an optical disk or a flash memory of the computer. The computer software comprises a series of instructions to make the computer (e.g., a personal computer, a service station or a network terminal) execute the method or a part thereof according to respective embodiment of the present disclosure.

The present disclosure being thus described, it will be obvious that the same may be varied in many ways. Such variations are not to be regarded as a departure from the spirit and scope of the present disclosure, and all such modifications as would be obvious to those skilled in the art are intended to be included within the scope of the following claims.

1. A method for a network element, the method comprising:
determining multiple concurrent measurement gap (MG) patterns;
encoding a message for transmission to a user equipment (UE) including MG configuration information that includes an indication of the multiple concurrent MG patterns, wherein the indication of the multiple concurrent MG patterns includes at least time offsets for respective MG patterns; and
transmitting the message to the UE.

2. The method according to claim 1, wherein the multiple concurrent MG patterns include first and second MG patterns, and wherein the time offset for the first MG pattern is equal to the time offset for the second MG pattern.

3. The method according to claim 1, wherein the multiple concurrent MG patterns include first and second MG patterns, the first MG pattern having a first measurement gap repetition period (MGRP) and a second MG pattern having a second MGRP, the second MGRP being no shorter than the first MGRP, and wherein the determining comprises:
determining configurations and the time offsets for respective MG patterns such that an MG according to the second MG pattern is in the middle of two adjacent MGs according to the first MG pattern.

4. The method according to claim 1, wherein the determining comprises:
determining configurations and the time offsets for respective MG patterns such that the minimum one of time intervals between every two adjacent MGs in time domain is not less than a minimum interval, wherein one of the every two adjacent MGs is according to a first MG pattern of the multiple concurrent MG patterns, and another of the every two adjacent MGs is according to a second MG pattern of the multiple concurrent MG patterns.

5. The method according to claim 4, wherein the minimum interval is defined in a 3GPP specification.

6. The method according to claim 4, wherein the minimum interval is determined based on a concurrent MG pattern ability of the UE.

7. The method according to claim 4, wherein the minimum interval is specified for:
the UE;
each of frequency ranges that are supported by the UE;
each of feature sets that are supported by the UE;
each of bands that are supported by the UE;
each of band-combinations that are supported by the UE;
each of component carriers (CCs) that are supported by the UE; or
each of carrier bandwidth parts (BWPs) that are supported by the UE.

8. The method according to claim 1, wherein the determining comprises:
determining configurations and the time offsets for respective MG patterns such that a total overhead of the multiple concurrent MG patterns is not greater than a maximum overhead.

9. The method according to claim 8, wherein the maximum overhead is determined based on a non-concurrent MG pattern supported by the UE.

10. The method according to claim 8, wherein the maximum overhead is determined based on a concurrent MG pattern ability of the UE.

11. The method according to claim 8, wherein the maximum overhead is specified for:
the UE;
each of frequency ranges that are supported by the UE;
each of feature sets that are supported by the UE;
each of bands that are supported by the UE;
each of band-combinations that are supported by the UE;
each of component carriers (CCs) that are supported by the UE; or
each of carrier bandwidth parts (BWPs) that are supported by the UE.

12. (canceled)

13. (canceled)

14. A method for a user equipment (UE), comprising:
encoding a message for transmission to a network (NW) element including concurrent MG pattern ability information of the UE, wherein the concurrent MG pattern ability information is based on multiple concurrent MG patterns that are supported by the UE; and
transmitting the message to the NW element.

15. The method according to claim 14, wherein the concurrent MG pattern ability information includes an indication of a minimum interval between two adjacent MGs in time domain that is supported by the UE, wherein one of the two adjacent MGs is according to a first MG pattern of the multiple concurrent MG patterns, and another of the two adjacent MGs is according to a second MG pattern of the multiple concurrent MG patterns.

16. The method according to claim 15, wherein the minimum interval is specified for:
the UE;
each of frequency ranges that are supported by the UE;
each of feature sets that are supported by the UE;
each of bands that are supported by the UE;
each of band-combinations that are supported by the UE;
each of component carriers (CCs) that are supported by the UE; or
each of carrier bandwidth parts (BWPs) that are supported by the UE.

17. The method according to claim 14, wherein the concurrent MG pattern ability information includes an indication of a maximum overhead that is supported by the UE.

18. The method according to claim 17, wherein the maximum overhead is specified for:
the UE;
each of frequency ranges that are supported by the UE;
each of feature sets that are supported by the UE;
each of bands that are supported by the UE;
each of band-combinations that are supported by the UE;
each of component carriers (CCs) that are supported by the UE; or
each of carrier bandwidth parts (BWPs) that are supported by the UE.

19. The method according to claim 17, wherein the indication of a maximum overhead includes an enumerated variable.

20. (canceled)

21. (canceled)

22. An apparatus, comprising:
a memory configured to store concurrent MG pattern ability information of a user equipment (UE), wherein the concurrent MG pattern ability information is based on multiple concurrent MG patterns that are supported by the UE; and
processor circuitry, coupled to the memory, configured to cause the UE to:
retrieve the concurrent MG pattern ability information from the memory;
encode a message for transmission to a network (NW) element including the concurrent MG pattern ability information; and
transmit the message to the NW element.

23. (canceled)

24. (canceled)
